(19) United States
(12) Patent Application Publication
(10) Pub. No.: US 2024/0420943 A1
(43) Pub. Date: Dec. 19, 2024

(54) AXIAL ION SOURCE

(71) Applicant: Thermo Fisher Scientific (Bremen) GmbH, Bremen (DE)

(72) Inventors: Ulf Fröhlich, Bremen (DE); Johannes Schwieters, Bremen (DE)

(73) Assignee: Thermo Fisher Scientific (Bremen) GmbH, Bremen (DE)

(21) Appl. No.: 18/744,091

(22) Filed: Jun. 14, 2024

(30) Foreign Application Priority Data
Jun. 19, 2023 (GB) 2309163.0

(51) Int. Cl. H01J 49/14

(52) U.S. Cl. CPC H01J 49/147

(57) ABSTRACT

An electron impact ion source comprises: a first ionisation region comprising an aperture configured to receive first molecules into the first ionisation region, the first ionisation region being configured to receive an electron beam along a first axis to generate a first ion beam along the first axis from the first molecules; and a second, separate ionisation region comprising an inlet configured to receive second molecules into the second ionisation region, the second ionisation region configured to receive the electron beam along the first axis to generate a second ion beam along the first axis from the second molecules.

### CROSS REFERENCE TO RELATED APPLICATION

This application claims priority from application GB 2309163.0, filed Jun. 19, 2023. The entire disclosure of application GB 2309163.0 is incorporated herein by reference.

### FIELD

The disclosure relates generally to ion generation, as used in analytical techniques including mass spectrometry for example, and specifically to electron impact ion sources, methods of electron impact ionisation and analytical instruments comprising an electron impact ion source.

### BACKGROUND

In electron impact (EI) ion sources (also known as electron ionisation ion sources), electrons are typically emitted from a heated filament and are accelerated into an ionisation volume containing sample gas molecules. Sample gas molecules are ionized by electron impact and are extracted from the ionisation volume by using extraction electrodes. In most EI sources, one or more permanent magnets are employed to focus and guide the ionizing electron beam through the ionisation volume.

The traditional EI source is a crossed-beam ion source (Nier-type ion source), and an example of this ion source is described in I. G. Brown, The Physics and Technology of Ion Sources, Wiley, 2004. A typical crossed-beam ion source is illustrated in FIG. 1. In these EI sources, a positive voltage is typically applied between a pusher electrode P and extraction electrode E that accelerates and focuses generated ions through a slit in the extraction electrode E. Ions generated close to the hole where electrons enter the ionisation volume are drawn into the hole, while ions generated at larger distances from the ion beam axis do not make it through the slit in the extraction electrode E. As a result, only a small fraction of ions created in region R of FIG. 1 are extracted from the ion source and are made available to a mass spectrometer.

A more recent development is an axial EI ion source. In axial ion sources, the electron beam axis is parallel to the ion beam axis. An example of this type of ELI source is described in Park et al, “Effect of magnetic field in electron-impact ion sources and simulation of electron trajectories,” Review of Scientific Instruments 77. The schematics of ion extraction from an axial source is shown in FIG. 2. A positive voltage is applied between two extraction electrodes E1 and E2, which causes the electrons to turn back towards the heated filament, whilst also extracting ions from the ionisation volume. In this configuration, the ionisation volume is the region between pusher electrode P and extraction electrode E1. A small positive voltage may be applied between pusher electrode P and extraction electrode E1 to drag ions to the source exit. This may also prevent ions from being drawn into the hole in the pusher electrode where electrons enter the ionisation volume.

Since the generated ions travel along the ion source axis and ions can be prevented from being drawn into the hole, ion extraction efficiency may be improved with the axial ion source compared to the Nier-type ion source. High extraction efficiency of the axial ion source may correspond to high sensitivity, which may be useful in gas chromatography mass spectrometry (GC-MS), for instance. In GC-MS, the axial ion source may be used in, for instance, a quadrupole or sector-field mass spectrometer.

U.S. Pat. No. 9,117,617 describes an ion source having a body comprising an ionisation chamber positioned along a source axis and a lens assembly also positioned along the source axis. The lens assembly comprises an extractor positioned at an end of the ionisation chamber and a first lens element outside the ionisation chamber and spaced apart from the extractor along the source axis. The extractor directs the ion beam out of the ionisation chamber along the source axis and the first lens element reflects an electron beam back towards the electron source. However, the electrodes of the ion source are likely to be contaminated by molecules introduced into the body. Furthermore, these electrodes are difficult to clean in-situ and removing the body for regular cleaning reduces sample throughput.

WO 2021/078368 relates to a mass spectrometer comprising a gas inlet adapted to supply a sample gas to be ionised into an ionisation region, a calibration unit adapted to supply calibration gas to be ionised to the same ionisation region and an ionization unit adapted to ionize the sample gas and/or the calibration gas in the ionization region, wherein the calibration unit comprises at least one evaporation source for generating the calibration gas by evaporating a source material. However, the ionisation efficiency of the sample gas in this arrangement is limited. Furthermore, this arrangement complicates or prevents the use of common calibration gases, such as perfluorokerosene or perfluorotributylamine.

U.S. Pat. No. 7,541,597 describes an in-situ method for cleaning ion source electrodes in a mass spectrometer by plasma etching. There may also be a small amount of non-reactive ion etching (“sputtering”). However, this method does not work well for more complicated ion source geometries or ion sources having regions of small dimensions, as the method relies on the plasma being able to reach the regions requiring cleaning.

WO 2018/231631 relates to an ion source that includes a gas source, nozzle, electron source, and electrodes. The gas source delivers gas via the nozzle to an evacuated ionisation volume and is at a higher pressure than that of the evacuated ionisation volume. Gas passing through the nozzle freely expands in an ionisation region of the ionisation volume. The electron source emits electrons through the expanding gas in the ionisation region to ionize at least a portion of the expanding gas. The electrodes create electrical fields for ion flow from the ionisation region to a mass filter and are located at distances from the nozzle and oriented to limit their exposure to the gas. However, the ionisation efficiency of this arrangement is limited.

Overcoming the issues noted above is desirable.

### SUMMARY

Against this background, there is provided a method and ion source for providing ions to a mass analyser or another downstream element. Additional aspects appear in the description and claims.

The present disclosure relates to an axial EI ion source. A flow of first molecules is provided into a first ionisation region of the EI source that is configured to receive an electron beam along a first axis. A first ion beam is generated along the first axis from the first molecules. The electron beam is also provided into a second ionisation region of the EI source, which is separate from the first ionisation region, along the first axis. A flow of second molecules is further provided into the second ionisation region to generate a second ion beam along the first axis from the second molecules. In other words, during operation of the EI source, the electron beam is available along the length of the first and second ionisation regions to generate the first and second ion beams. That is, a single electron beam is used to generate ions in at least two, separate ionisation regions.

This EI source configuration may mean that may allow the conditions of each ionisation region to be separately operated. This may enable the EI source to be more finely controlled and may allow advantages associated with different operation modes to be achieved. For example, one ionisation region may be operated to enable a high ionisation efficiency while the other ionisation region may be operated to enable improved ion beam focussing. In another example, the pressure inside each ionisation region may be individually controlled, which may allow the ionisation efficiency of molecules within each ionisation region to be separately monitored and/or adjusted. This may improve the overall ionisation efficiency of the EI source.

In a further example, providing two, separate ionisation regions may allow contamination of the ion source electrodes to be limited, reduced or minimized. For example, molecules that are more likely to contaminate the ion source electrodes may be kept away from the ion source electrodes (for instance, by being introduced into an ionisation region distal from the ion source electrodes or by being introduced along the second axis). The ion source electrodes may be one or more of: a lens or electrode for focussing the electron beam, a lens or electrode for extracting ions, a lens or electrode for reflecting electrons or the electron beam, or another electrode.

Reducing or limiting the contamination may enable long-term stability and high sensitivity of the ion source to be maintained, as fewer ions may be lost on negatively charged regions. The tunings of the EI source (or analytical instrument comprising the EI source) can thus be more robust. Furthermore, the lifetime and analytical robustness of the high sensitivity setup may be improved, and may be around five times greater or more. There may also be a reduced risk of the electron beam being blocked by negative charge build up. Moreover, more complicated geometries can be kept clean (or have reduced contamination) without the need for regular cleaning sessions, which may enable higher sample throughput and ease of use. The costs of analysis may therefore also be reduced.

Preferably, the flow of second molecules is provided along a second axis that intersects the first axis to ionise the second molecules. The second ionisation region may be configured to receive the ion beam from the first ionisation region along the first axis. In other words, the second ionisation region may be arranged subsequent to (or downstream of) the first ionisation region. The electron beam may be reflected back from the second ionisation region and the ions extracted for transmission to a mass analyser or another downstream element.

The present disclosure also relates to another consideration of an axial EI ion source (which may be combined with the earlier discussion). A flow of molecules is provided into a first ionisation region of the EI source that is configured to receive an electron beam along a first axis and to operate at a high or ultra-high vacuum. An ion beam is generated along the first axis from the molecules in the first ionisation region. The electron beam may be reflected back towards the receiving portion of the first ionisation region and the ions extracted for transmission to a mass analyser or another downstream element.

Operating the first ionisation region under high vacuum conditions may mean that the molecules may not have a high probability of colliding with other molecules, and so may form a (substantially) directed beam of molecules. Contamination of ELI source electrodes may thus be limited, reduced or prevented, since the molecules may not be directed towards the electrodes. Furthermore, generation of ions in the region near the EI source electrodes may be suppressed due to the high vacuum conditions. This may result in a less broad (more monoenergetic) distribution of ion kinetic energies, which may in turn result in better focussing of the ion beam into a detector of the mass analyser.

In accordance with a first aspect, there is provided an electron impact ion source comprising:
a first ionisation region comprising an aperture configured to receive first molecules into the first ionisation region, the first ionisation region being configured to receive an electron beam along a first axis to generate a first ion beam along the first axis from the first molecules; and
a second, separate ionisation region comprising an inlet configured to receive second molecules into the second ionisation region, the second ionisation region configured to receive the electron beam along the first axis to generate a second ion beam along the first axis to ionise the second molecules.

An electron impact ion source that may enable the advantages discussed above may thus be provided.

In accordance with a second aspect, there is provided a method of electron ionisation comprising:
receiving an electron beam into a first ionisation region along a first axis and generating, by the electron beam, a first ion beam along the first axis from first molecules in the first ionisation region; and
receiving the electron beam into a second, separate ionisation region along the first axis and generating, by the electron beam, a second ion beam along the first axis from the second molecules.

In accordance with a third aspect, there is provided an electron impact ion source comprising:
an ionisation region comprising an aperture configured to receive molecules into the ionisation region, the ionisation region being configured to operate at a high vacuum and to receive an electron beam along a first axis to generate an ion beam along the first axis from the molecules.

An electron impact ion source that may enable the advantages discussed above may thus be provided.

In accordance with a fourth aspect, there is provided a method of electron ionisation comprising:
receiving an electron beam into an ionisation region along a first axis and generating, by the electron beam, an ion beam along the first axis from first molecules in the first ionisation region; and
operating the first ionisation region at a high vacuum.

The electron impact ion sources described above may be implemented in an analytical instrument.

The methods described above may be implemented as a computer program comprising instructions to operate a computer or computer system. The computer program may be stored on a non-transitory computer-readable medium.

The computer or computer system (or other hardware and/or software configured to implement the method) may be embodied as a controller configured to operate an analytical instrument. The above methods may be implemented in a system comprising an analytical instrument and the controller.

It should be noted that any feature described herein may be used with any particular aspect or embodiment of described herein. Moreover, the combination of any specific apparatus, structural or method features is also provided, even if that combination is not explicitly disclosed.

The invention will now be described with reference to the attached drawings depicting different embodiments thereof, the drawings being provided purely by way of example and not limitation.

### BRIEF DESCRIPTION OF DRAWINGS

The invention may be put into practice in a number of ways, and preferred embodiments will now be described by way of example only and with reference to the accompanying drawings, in which:

FIG. 1 schematically illustrates a cross-beam (Nier-type) ion source;

FIG. 2 schematically shows an axial ion source;

FIG. 3 illustrates a graph of a decrease in signal intensity of a triple quadrupole GC-MS/MS system exposed to a constant flow of PFTBA into an ion source over several hours;

FIG. 4 schematically illustrates an ion source comprising two ionisation regions;

FIG. 5A shows a diagram of an ion source comprising two beam-intersection ionisation regions and an additional ionisation region;

FIG. 5B schematically illustrates an ion source comprising two beam-intersection ionisation regions in which the received molecules are directed away from ion source electrodes, and an additional ionisation region;

FIG. 6 schematically depicts an ion source comprising two beam-intersection ionisation regions;

FIG. 7 illustrates schematically an ion source comprising two ionisation chambers and a corresponding exemplary potential within the ion source;

FIG. 8 shows one embodiment of an ion source comprising an ionisation chamber and a beam-intersection ionisation region;

FIG. 9 illustrates an embodiment of an ion source comprising two beam-intersection ionisation regions and a further ionisation region arranged between the two beam-intersection ionisation regions; and

FIG. 10 shows a graph illustrating a difference in peak shape for a conventional axial ion source compared to an axial ion source with minimum ionization occurring in the region around extraction electrodes E1 and E2.

FIG. 11 schematically shows an analytical instrument, such as a mass spectrometer (for example), in which an ion source according to the disclosure can be utilized.

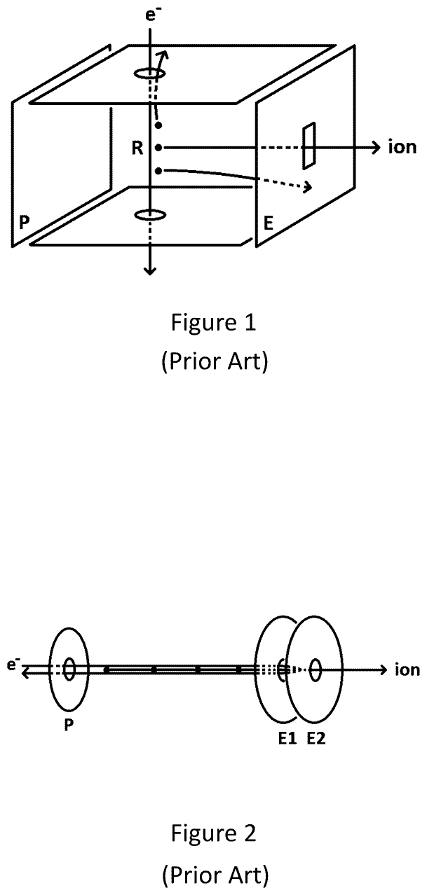

It should be noted that the Figures are illustrated in schematic form for simplicity and are not necessarily drawn to scale. Like features are provided with the same (or similar) reference numerals.

### DESCRIPTION OF PREFERRED EMBODIMENTS

In typical ion sources, sample and calibrant molecules (usually in gaseous form) are introduced into a single ionisation volume of the ion source. The sample and calibrant molecules intermix in the single ionisation volume and are ionised by the electron beam. The ionised sample and calibrant molecules are then transmitted to a mass analyser via extraction electrodes, whilst the electron beam is reflected back via the extraction electrodes (axial source) or collected on an electrode opposite to the electron entrance hole (crossed-beam source). Calibrant molecules are typically known atomic masses or mass-to-charge (m/z) ratios, which produce calibration peaks corresponding to the known m/z values in a measured mass spectrum. The calibration peaks can thus be used to determine the mass-to-charge ratios of peaks corresponding to unknown molecules.

As the sample and calibrant molecules are intermixed in the single ionisation volume, the same operating conditions of the ion source are used to ionise both the sample and calibrant molecules. However, although certain operating conditions may be more beneficial for the sample molecules than for the calibrant molecules, it is not possible in conventional ion sources to individually tailor the operating conditions for each set of molecules in the ionisation region.

Elevated gas pressure within the ionisation volume may increase ionisation efficiency, in addition to high extraction efficiency that may be obtained with the axial ion source. However, elevated gas pressure within the ionisation volume may also accelerate contamination of the ion source electrodes. In particular, insulating layers of sample and calibrant molecules may form on ion source electrodes, which then may be electrically charged by impinging electrons. Ions may then be lost on these negatively charged regions. As an example, a circular region around an aperture may be particularly susceptible to charging. The axial ion source is particularly prone to loss of ions on negatively charged regions, as there is typically no substantial electric field gradient within the ionisation volume. In extreme cases, the negative charge may build up sufficiently to completely block the electron beam.

Contamination of the ion source may become an even more severe problem when using calibrants such as perfluorokerosene (PFK) or perfluorotributylamine (PFTBA, also known as FC43). These calibrants may be used, for example, to tune the ion source or to provide lock masses during measurement. Calibrant compounds such as PFK and PFTBA, for example, tend to strongly contaminate the ion source electrodes, often leading to visible coatings formed on the electrodes.

A lock mass is an ion of a known mass-to-charge ratio that may allow real-time recalibration by correction of m/z shifts arising from instrument drift. Lock masses may allow an analytical instrument to rapidly shift to relevant parts of a mass spectrum. This can be used to analyse small regions around peak centres more quickly and easily. This may be particularly useful for dioxin measurements, which may be performed using a magnetic sector GC-MS instrument, for example.

A supply of the lock mass may be required throughout analysis. For instance, method 1613B of the US Environmental Protection Agency (EPA) is considered the “gold standard” for dioxin analysis. The method 1613B requires the use of high resolution GC-MS, as well as continuous measurement of a PFK lock mass simultaneously with measurement of dioxin samples. To obtain a valid measurement, signal intensity of the PFK lock mass is stable, as specified in the method 1613B. However, constant flow of PFK into the ion source over several hours poses a challenge for axial ion sources having a closed ionisation volume. For example, the contamination issues discussed above may typically result in a decrease in signal intensity over a time period that may make using a lock mass difficult to implement or require further time and labour to correct for the decrease in signal intensity. Achieving the gold standard may thus be difficult, particularly after many experiments.

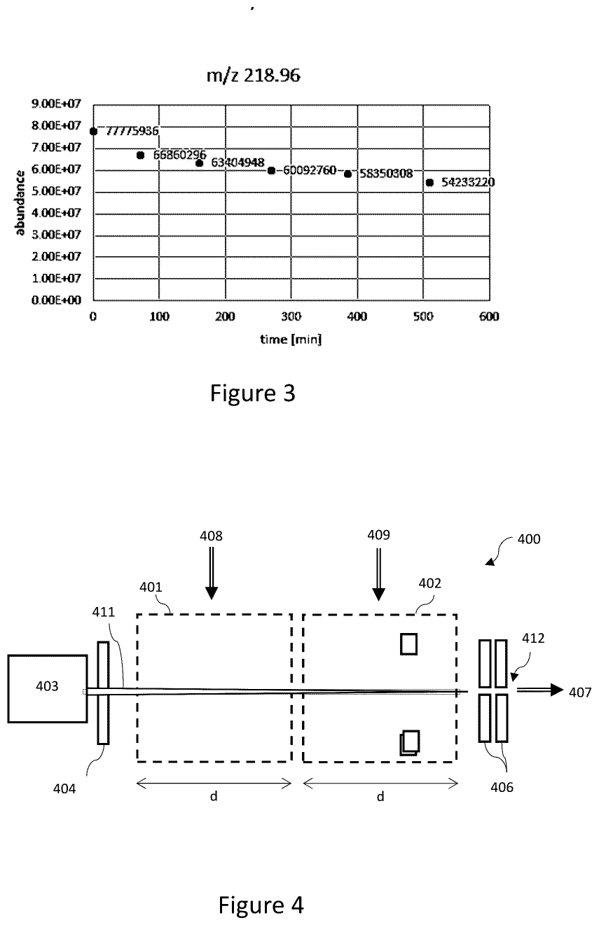

FIG. 3 illustrates the decrease in signal intensity of a triple quadrupole GC-MS/MS system exposed to a constant flow of PFTBA into the ion source over several hours. As can be seen from the results, the decrease in abundance after around an hour is significant. It is evident that it is difficult to achieve the gold standard using axial ion sources in current instruments. Whilst it may be possible to obtain measurements complying with the 1613B standard using a crossed-beam ion source (since crossed-beam ion sources may be less prone to contamination), using a crossed-beam source means foregoing the increased sensitivity that it is possible to achieve with an axial ion source. Therefore, it is preferable to provide an axial ion source having a lower contamination rate.

FIG. 4 schematically shows an example implementation of an ion source. The ion source 400 comprises an electron source 403, an electron lens (pusher electrode) 404, a first ionisation region 401, a second ionisation region 402, and reflection and extraction electrodes 406. The ion source 400 may be surrounded by a vacuum environment (which may be a high vacuum). The electron lens 404 and reflection and extraction electrodes 406 may be referred to collectively as a plurality of lenses 404, 406 or a plurality of electrodes 404, 406. The ion source may be an axial ion source, meaning that both electrons and ions move along a common axis of the ion source. This may be achieved by an axial magnetic field. The axial magnetic field may also focus the ion beam. In other words, the use of a magnetic field rather than, for example, an electric RF field, may allow the ion beam (which may be made up of positive ions) and electron beam 411 to travel or be passed along the common axis.

Both (static) magnetic and electric RF fields can be used to focus positively as well negatively charged particles. However, an electric RF field may not allow both ions and electrons (having a mass-to-charge ratio that is typically four orders of magnitude smaller than that of the ions) to be constrained within the ion source 400 simultaneously. In particular, in an electric RF ion guide, the electric field is zero (or close to zero) along the ion guide axis but becomes non-zero and quickly increases when deviating from the ion guide axis. An ion (positively or negatively charged) moving away from the ion guide axis thus moves into a region of high electric RF field and is pushed back to the ion guide axis as a result of many cycles of the oscillating electric RF field acting on the ion. In contrast, an electron (being much lighter than an ion) can move fast enough through the ion guide that the electric RF field (with a frequency in the MHz range) appears static to the electron. Thus, the electron is simply deflected away from the ion guide axis and attracted towards an ion guide electrode that is positive (at the time the electron is moving through the ion guide), rather than being focused along the ion guide axis.

In other words, while an electric RF field with a typical frequency in the MHz range may be used to constrain ions within the ion source, that same electric RF field is seen as rather a static field by the much faster moving electrons. As a result, the electrons may be deflected away from the source axis and attracted towards those RF multipole electrodes, which are positive at the time the electrons move within the ion source. In contrast, the focusing action of magnetic fields is stronger for lighter particles than for heavier particles. For example, a magnet in the axial ion source may strongly focus electrons (an electron beam) along the source axis whilst having a negligible focusing action on the (much heavier) ions. Thus, using one or more magnets in the axial ion source may allow both an ion beam and electron beam to be focussed within the ion source.

Referring still to FIG. 4, an electron beam 411 is emitted along a first axis from the electron source 403, which may comprise a cathode configured for thermionic emission (not shown). For example, the cathode may comprise one or more filaments, which may be composed of tungsten or rhenium wire (or an alloy thereof), for example. The cathode is heated to incandescent temperature to emit electrons, which may typically be achieved by passing a current through the cathode.

The resulting electron beam 411 may be focussed into the first ionisation region via the electron lens 404 (which may be any suitable electrode or plurality of electrodes for focussing an electron beam). In other words, the electron lens 404 may be configured to receive a voltage or voltages to generate an electric field, thereby to direct or focus the electron beam into the first ionisation region. The electron lens 404 also may be configured to push away ions from the electron entrance hole. The electron beam 411 is preferably collimated into the first ionisation region by a magnetic field generated by one or more magnets, which may be permanent or non-permanent (for example, semi-permanent) magnets. For example, a disc-shaped magnet may be placed behind the electron source 403 to generate a magnetic field. Additional magnets may be used as well.

The use of one or more magnets may be useful in electron impact ionisation regions. This is because electron impact converts a molecule into a positive ion, thus resulting in positive ions and negative electrons being present in the electron impact ionisation region. Using an electric RF field may cause the electrons (having a mass-to-charge ratio that is typically four orders of magnitude smaller than that of the ions) to be ejected from the ion source (as the electric RF field appears to be relatively static for the fast moving electrons). In contrast, a magnetic field may allow both an ion beam and the electron beam 411 to be constrained within the ion source 400 and thus allowing both to enter the second ionisation region 402.

The magnetic field is preferably applied parallel to the direction of the electron beam 411. Electrons may thus travel along a helical path, which may increase their path length and thereby increase the probability of electron collisions.

First molecules 408 (which may comprise sample molecules to be analysed or calibrant molecules) are introduced into the first ionisation region 401 via a first aperture or inlet, where ions can be generated by collisions of neutral molecules with electrons in the electron beam 411. Collisions may result in positive or negative ions. For example, an electron in the electron beam may cause the neutral molecule to eject an electron due to a transfer in kinetic energy, resulting in a positive ion. In another example, the electron may be captured by the neutral molecule, resulting in a negative ion.

The first ionisation region 401 comprises the first aperture or inlet. The aperture may be in the first ionisation region 401 itself (for example, an aperture in a wall of the first ionisation region 401) or the first ionisation region 401 may comprise a component having an aperture through which the first molecules 408 are received (which may also be referred to as a molecule delivery element). For example, the first ionisation region 401 may comprise a nozzle or tube (such as, for example, a capillary tube) or another component having an opening.

The first molecules 408 may be received into the first ionisation region 401 as a flow or beam of molecules and may be received from an analytical instrument such as, for example, a gas chromatograph. A molecular beam may be produced by allowing a gas at higher pressure to expand through a small aperture into a chamber at lower pressure.

The molecules 408 may be received as a (substantially) continuous flow of the molecules for use as a lock mass. The decrease in signal intensity of the continuous flow over a period of time may be less than 10%, 5%, 1% or another value. The period of time may be on the order of several hours and may be, for example, between 5 and 10 hours.

The electron beam 411 ionises the first molecules 408 in the first ionisation region 401 and the resulting ion beam 407 of first ions is generated along the first axis. That is, both the electron beam and the ion beam 407 travel along the first axis. Since the first ionisation region 401 is configured for electron impact ionisation, the first ionisation region 401 may also be termed a “first electron impact ionisation region 401”. The ion beam 407 may be considered as comprising a “first ion beam”, as a beam of ions is generated from the first molecules. The ion beam 407 or first ion beam is guided into the second ionisation region 402. Second molecules 409 (which may be sample molecules to be analysed, calibrant molecules or a lock mass) are introduced into the second ionisation region 402. The second molecules 409 may also be received into the second ionisation region 402 via a second aperture or inlet and may be received as a beam of molecules. The second molecules 409 may be received from an analytical instrument such as, for example, a gas chromatograph.

The second ionisation region 402 comprises the second aperture or inlet. The second aperture may be in the second ionisation region 402 itself (for example, an aperture in a wall of the second ionisation region 402) or the second ionisation region 402 may comprise a component having an aperture through which the second molecules 408 are received (which may also be referred to as a molecule delivery element). For example, the second ionisation region 402 may comprise a nozzle or tube (such as, for example, a capillary tube) or another component having an opening.

The electron beam 411 ionises the second molecules 409 in the second ionisation region 402. In other words, the ion beam 407 further includes second ions. Since the second ionisation region 402 is configured for electron impact ionisation, the second ionisation region 402 may also be termed a “second electron impact ionisation region 402”. The ion beam 407 may thus be considered as comprising the first ion beam and a “second ion beam” generated from the second molecules. The electrodes 406 (which may be within or adjacent to the second ionisation region 402) are configured to receive voltages to extract ions from the second ionisation region 402 (including the ions received into the second ionisation region 402 from the first ionisation region 401) and to reflect the electron beam 411.

The first and second molecules 408, 409 are ionised in the respective first and second ionisation regions 401, 402 to generate the ion beam 407 along the first axis. The ion beam 407 may be supplied to a mass analyser or a downstream element. A (small) positive voltage may be applied between the electron lens 404 and the reflection/extraction electrodes 406 to cause positive ions to move towards an ion source exit 412. In other words, an axial gradient may be applied between the electron lens 404 and the reflection and extraction electrodes 406. The positive voltage also may prevent ions from being drawn into a hole in the electron lens 404 from which the electrons enter the first ionisation volume 401. In examples in which negative ions are generated, a (small) negative voltage may be applied between the electron lens 404 and the reflection and/or extraction electrodes 406.

At least one of the first ionisation region 401 and the second ionisation region 402 may be configured to receive the first molecules 408 or second molecules 409, respectively, along a second axis (not shown) that intersects the first axis. Stated another way, the flow of the molecules 408 and/or 409 may overlap the electron beam 411 that is received into the at least one ionisation region. The first and/or second molecules 408 and/or 409 can be efficiently ionised by the electron beam 411 as a result of the intersection of the second axis with the electron beam 411. When the molecules 408 and/or 409 are provided along the second axis, the molecules 408 and/or 409 may not be directed towards or come into contact with the ion source electrodes 404 and/or 406. Thus, contamination of the ion source electrodes 404 and/or 406 may be prevented or reduced.

In other words, there may be provided an electron impact ion source comprising: a first ionisation region comprising an aperture configured to receive first molecules into the first ionisation region, the first ionisation region being configured to receive an electron beam along a first axis to generate an ion beam along the first axis from the first molecules; and a second, separate ionisation region configured to receive the electron beam along the first axis, the second ionisation region comprising an inlet configured to receive second molecules into the second ionisation region along a second axis that intersects the first axis to ionise the second molecules.

A corresponding method of electron ionisation may be provided, the method comprising: receiving an electron beam into a first ionisation region along a first axis and generating, by the electron beam, an ion beam along the first axis from first molecules in the first ionisation region; and receiving the electron beam into a second, separate ionisation region along the first axis and receiving second molecules into the second ionisation region along a second axis that intersects the first axis to generate an ion beam along the first axis from the second molecules.

Preferably, the second axis may be perpendicular to the first axis. Thus, a simple arrangement may be provided in which contamination of the ion source electrodes 404 and/or 406 can be limited, prevented or reduced. In another example, the angle of intersection may be selected based on the position of the ion source electrodes 404 and/or 406 relative to the ionisation region in which the molecules 408 and/or 409 are received along the second axis. The angle of intersection may be selected to direct molecules away from a plane of the ion source electrodes 404 and/or 406, for instance.

Although the individual molecules in the molecular beam may travel along different paths, the molecular beam may have an overall direction of travel. In one example, the angle of intersection may be selected such that the direction of travel of the molecular beam is at least partially counter (opposite) to the electron beam travel direction. At least partially counter may mean that a vector component of the molecular beam direction of travel is antiparallel to a vector component of the electron beam travel direction (the vector components are opposite in direction). Preferably, the direction of travel may be at least partially counter to the electron beam travel direction when the ionisation region 402 is adjacent to extraction and reflection electrodes 406. Although the molecular beam may thus be directed at least partially towards the electron lens 404, the contamination of the electron lens 404 may still be avoided, reduced and/or limited. For example, the angle of intersection may be an angle such that the second molecules cannot or are unlikely to reach the ion source electrodes. The angle may be between 70 to 90 degrees, for instance. Additionally or alternatively, a length d of the ionisation region 402 may be sufficiently large such that the second molecules 409 do not or are unlikely to reach the electron lens 404. Additionally or alternatively, there may be a separation element between the ionisation region 402 and the electron lens 404, such that the second molecules are similarly unable or unlikely to reach the ion source electrodes. Other arrangements are possible that may mean the contamination of the electron lens 404 can be reduced or limited.

In another example, the angle of intersection may be selected such that the direction of travel of the molecular beam is at least partially parallel to the electron beam (for example, when the ionisation region 401 is adjacent to the electrode lens 404). At least partially parallel may mean that the vector component of the molecular beam direction of travel is parallel to the vector component of the electron beam travel direction (the vector components have the same direction). As discussed above with respect to the electron lens 404, although the molecular beam may be directed at least partially towards the extraction and reflection electrodes 406, the contamination of the extraction and reflection electrodes 406 may still be avoided, reduced and/or limited.

In addition to or instead of receiving the molecules 408 or 409 along the second axis, one or both of the ionisation regions 401, 402 may be configured to operate at a high vacuum. Stated another way, an axial ion source may be provided in which part(s) of the electron beam is/are placed in a high vacuum. The high vacuum may be achieved by the use of a vacuum pump (or a series of vacuum pumps), which may be connected (directly or indirectly) to the at least one ionisation region. There may only be one ionisation region in cases where the ionisation region is configured to operate at a high vacuum.

A high vacuum corresponds to a lower pressure within the ionisation region (compared to the pressure ranges conventionally used in ionisation regions), which may reduce the probability of generating ions from the electron beam 411. The high vacuum region may thus result in less ionisation (although sufficient ionisation efficiency may be maintained or improved by, for example, introducing molecules along the second axis). This may in turn enable efficient prevention or reduction of contamination of the ion source electrodes 404 and/or 406. Preferably, the one or both of the ionisation regions 401, 402 configured to operate at a high vacuum may also be configured to receive the molecules 408 and/or 409 along the second axis. This may allow for particularly efficient prevention or reduction of the contamination, as the molecules may not be directed towards the electrodes 404 and/or 406 and may have a reduced probability of reaching the electrodes 404 and/or 406.

The vacuum may be a high or ultra-high vacuum, which may improve the reduction or prevention of the contamination. The ion source 400 may be configured to operate at high or ultra-high vacuum in one or more ways. In one example, the at least one ionisation region 401 and/or 402 may be configured such that the length d of the at least one ionisation region 401 and/or 402 along a dimension parallel to the first axis is smaller than two times the mean free path of the molecules 408 and/or 409. Stated another way, the mean free path of the molecules 408 and/or 409 may be more than half (0.5 times) the length d of the at least one ionisation region 401 and/or 402. The molecules 408 and/or 409 may thus travel in straight lines to form a substantially directed beam of molecules. Accordingly, the molecules 408 and/or 409 may not be deflected by collisions with other molecules and thus may be less likely to contaminate the ion source electrodes. Preferably, the mean free path is greater than the length d, and most preferably is at least ten times greater than the length d.

Optionally, at least one ionisation region may be configured to operate at a pressure equal to or less than 0.1 Pa (1×10⁻³ mbar) or a pressure less than or equal to 10⁻⁶ Pa (10⁻⁸ mbar). High vacuum may correlate to a pressure in the range of 1×10⁻⁶ Pa to 0.1 Pa (1×10⁻⁸ mbar to 1×10⁻³ mbar), and ultra-high vacuum may correspond to a pressure in the range of 1×10⁻⁹ Pa to 1×10⁻⁶ Pa (1×10⁻¹¹ mbar to 1×10⁻⁸ mbar), as defined in ISO 3529-1:2019. However, it will be appreciated that another pressure range may be used, as the pressure range corresponding to a high or ultra-high vacuum may depend on various factors such as dimensions of the ionisation volume, temperature within the ionisation volume, and species of molecule within the ionisation region, for example. For molecules having a larger collisional cross-section such as, for example, PFK or FC43, the pressure in the ionisation region may need to be lower than 10⁻³ mbar to avoid or sufficiently reduce collisions. A larger volume ionisation region may likewise require a pressure lower than 10⁻³ mbar to sufficiently reduce collisions. Preferably, the pressure range corresponds to operating the at least one ionisation region at high or ultra-high vacuum.

The presence of molecular flow (and hence, the high or ultra-high vacuum regime) can be determined in a straightforward and empirically verifiable manner by the Knudsen number. The Knudsen number is a dimensionless number defined as

$$Kn = \frac{λ}{L} ,$$

where λ is the mean free path and L corresponds to a physical length, which may be a length of the ionisation region in one dimension (for example, the dimension parallel to the first axis). At Knudsen numbers greater than 0.5, the probability of molecules colliding may be low or substantially zero, such that the molecular flow may correspond to high vacuum conditions. Preferably, the Knudsen number is more than or equal to 1. Most preferably the Knudsen number is more than or equal to ten, to further reduce the probability of molecular collisions. Molecules may thus be in free molecular flow.

Referring still to FIG. 4, the first ionisation region 401 is separate from the second ionisation region 402. This may allow conditions of the first ionisation region 401 to be operated separately from conditions of the second ionisation region 402. The conditions may be set by one or more operating parameters of the EI source, which may include a pressure within the respective ionisation region, one or more voltages to be applied to one or more ion source electrodes, an axis along which the respective molecules are to be received or introduced, or another operating parameter. In one example, the first ionisation region 401 may be operated at an elevated pressure and molecules may be introduced into the second ionisation region 402 along the second axis that intersects the first axis.

In an example, the first and second ionisation regions 401, 402 may be spatially separated (offset from each other). The offset may be along a dimension parallel to the first axis. In the case where the first and second ionisation regions 401, 402 are spatially separated, the first molecules 408 may be predominantly ionised in the first region 401 and second molecules 409 may be predominantly ionised in the second region 402. However, some of the first molecules 408 may be ionised in the second ionisation region 402 and vice versa. In other words, there may be some overlap between the two ionisation regions.

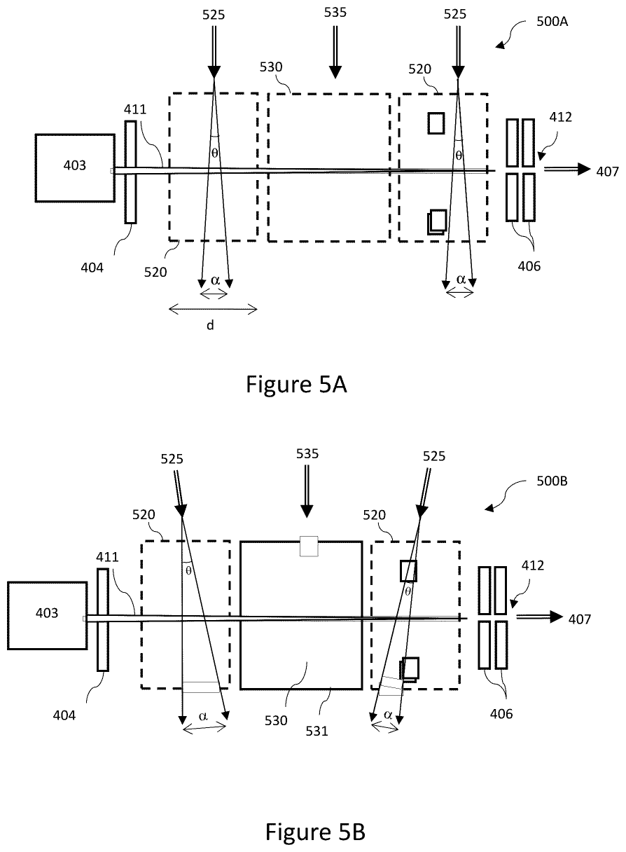

In another example, the first and second ionisation regions 401, 402 may be spatially separated such that there is no (or substantially no) spatial overlap between spatial and/or angular spreads of the first and second molecules 408, 409. In one example, the spatial separation may be achieved by providing a spacer region between the first and second ionisation regions. The spacer region may be a further ionisation region, as will be discussed with reference to FIGS. 5A, 5B and 9. Molecules need not be introduced into the spacer region or further ionisation region when it is present during operation of the ion source 400.

In another example, a length d of the first and/or second ionisation region 401, 402 along a dimension parallel to the first axis may be sufficiently large that the spatial spread of the first and second molecules 408, 409 has a low probability of overlap. For example, the probability of overlap may be less than 50%, less than 10%, less than 5% or less than 1%. The probability of overlap may also be less than another value.

In yet another example, there may be a separation element or barrier between the first and second ionisation regions 401, 402, which may be in addition to the spatial separation. Providing a barrier in addition to the spatial separation may further reduce or limit the contamination of ion source electrodes compared to spatial separation alone. The separation element may prevent or reduce the number of molecules exchanged between the two ionisation regions, which may mean that molecules in the first region are predominantly ionised in the first region and molecules in the second region are predominantly ionised in the second region. The separation element may, for example, be a separating wall between the first and second ionisation regions 401, 402.

The separating wall may form part of a wall that at least partially encloses one or both of the first and second ionisation regions 401, 402. For example, one or both of the ionisation regions 401, 402 may be an ionisation chamber. Higher or highest sensitivity may be reached by providing an axial ion source having an ionisation volume that is at least partially closed. Preferably, one or both of the ionisation regions 401, 402 may be mostly closed. An ionisation volume that is at least partially or mostly closed may result in an elevated gas pressure within the ionisation volume. This may be a pressure in the range between 1×10⁻⁴ and 1×10⁻² mbar, although it will be appreciated that the pressure range may depend on various factors such as dimensions of the ionisation volume, temperature within the ionisation volume, and species of molecule within the ionisation region, for example.

In a further example, the separation element may be provided instead of the spatial separation. That is, the ionisation regions may spatially overlap such that molecules would not be predominantly ionised in a respective ionisation region apart from the presence of the separation element. The separation element may be sufficient to reduce or limit the contamination of the ion source electrodes.

The length d shown in FIG. 4 is illustrative only and need not be the same value for both of the first and second ionisation regions. The first and second ionisation regions 401, 402 (and spacer region, if present) may be of any appropriate size, and may be of different lengths or volumes. The spacer region, if present, may be the same length or volume as one of the first and second ionisation regions 401, 402, or may be of a different length or volume.

Although the first and second molecules 408 and 409 are illustrated in FIG. 4 as being introduced on a common side of the ion source 400, it will be appreciated that the molecules may be provided from different (for example, opposite) sides of the ion source 400. Similarly, the first and second molecules 408 and 409 need not be received along an axis orthogonal (perpendicular) to the first axis. Instead, the first and second molecules 408, 409 may be received at any suitable angle relative to the first axis. For example, in a region that transmits the ion beam 407 directly to the extraction and reflection electrodes 406, the molecules may be received along another axis at an angle between 90 and 180 degrees relative to the first axis. The molecules may therefore be directed at least partially counter to the direction of travel of the electron beam 411. In another example, in a region that receives the electron beam 411 directly from the electron lens 404, the molecules may be received along an axis at an angle of 90 degrees or less relative to the first axis. The molecules may thus be directed along the direction of travel of the electron beam 411. Either or both of these configurations may assist in avoiding electrode contamination, as either or both sets of molecules may not be directed towards the plurality of electrodes 404 and/or 406.

The ion source 400 may be implemented in an analytical instrument. The ion source 400 and/or components of the analytical instrument may be controlled by a controller (not shown). The controller may comprise a computer that functions as a data processor for receiving data from a mass analyser, the data representative of the quantity of mass analysed or detected ions from a mass analyser. The computer may also function as a data processor for processing the data to provide a mass spectrum and/or quantitative analysis of the ions. The controller may further comprise a display and user input device so that a user can view and enter or select information. The user input device may be a keyboard and/or a mouse.

The ionisation regions 401, 402 (and spacer region, if present) may be arranged in one of a number of ways. Exemplary implementations will be discussed with reference to FIGS. 5A, 5B and 6-10. However, it will be appreciated that implementations other than those schematically illustrated in FIGS. 5A, 5B and 6-10 are possible.

FIG. 5A illustrates an exemplary embodiment of the ion source illustrated schematically in FIG. 4. The ion source 500A comprises the electron source 403, the electron lens 404, the reflection and extraction electrodes 406, two beam-intersection ionisation regions 520 and a spacer region 530. The two beam-intersection ionisation regions 520 are ionisation regions where molecules 525 are introduced along an axis that intersects the first axis.

The spacer region 530 is positioned between the two beam-intersection ionisation regions 520 in FIG. 5, but the regions 520, 530 may be arranged in another manner. Furthermore, the ion source 500A may comprise a different number of each type of region. For example, only one beam-intersection ionisation region 520, or more than two beam-intersection regions 520 may be present. Similarly, more than one spacer region 530 or no spacer region 530 may be included in the ion source 500A.

Third molecules 535 (which may be sample molecules to be analysed or calibrant molecules) may be received into the spacer region 530. The spacer region may be a further ionisation region, and the third molecules 535 may be ionised as discussed above in relation to the first and second ionisation regions 401, 402 of FIG. 4. For example, the further ionisation region 535 may be configured to operate under high or ultra-high vacuum conditions and/or the third molecules 535 may be received into the further ionisation region 535 along an axis that intersects the first axis.

As discussed above with reference to FIG. 4, the ion source 500A may be configured to operate under high or ultra-high vacuum conditions by dimensioning at least one ionisation region such that the length d is smaller than the mean free path length. Additionally or alternatively, at least one ionisation region may be configured such that a spread of the molecules 525 and/or 535 along a dimension parallel to the first axis is less than the length d of the at least one ionisation region. For example, a spatial spread α of the molecules 525 and/or 535 (divergence of the molecular beam) may be less than the length d of the at least one ionisation region. Additionally or alternatively, the at least one ionisation region may be configured such that a spread of the molecules 525 and/or 535 does not intersect a plane of the ion source electrodes 404 and/or 406. For example, an angular spread θ of the molecules 525 and/or 535 may not intersect a plane of the ion source electrodes 404 and/or 406. Any of these options may be achieved by a sufficiently large ionisation region, an inlet that limits the spread (for example, spatial spread α and/or angular spread θ) of the molecules, an inlet that is positioned distal from the electrodes, and/or a pressure within the ionisation region that allows a majority of molecules (for example, 50% or more) to reach a side of the ionisation region opposite the inlet. The ionisation region may be configured such that a different percentage of molecules reaches the side opposite the respective aperture and/or inlet. For example, 40%, 60%, 80% or 90% of the respective first and/or second molecules may reach the side opposite the respective aperture and/or inlet. The spatial spreads α and angular spreads θ shown in FIG. 5A are illustrative only and may be of any suitable value.

FIG. 5B illustrates an exemplary embodiment of the ion sources illustrated schematically in FIGS. 4 and 5A. In FIG. 5B, the two beam-intersection ionisation regions 520 are calibrant ionisation regions and the ionisation region 530 is a sample ionisation region. The ionisation region 530 may be an elevated pressure ionisation region (typically between 1×10⁻⁴ and 1×10⁻² mbar), which may be realised by an at least partially closed ionisation chamber 531, or may be an ionisation region operated at high or ultra-high vacuum. As noted above in respect of FIG. 5A, a different number of each type of ionisation region 520, 530 may be present in the ion source 500B, and the ionisation regions 520, 530 may be arranged in one of a number of ways.

For example, a beam-intersection ionisation region 520 may be positioned before and/or after the ionisation region 530. Calibrant molecules 525 may be introduced along an axis at any suitable angle relative to the axis of the electron beam 411. Preferably though, the calibrant molecules 525 may be received along an axis that does not intersect a plane of the ion source electrodes 404 and/or 406. In other words, the axis may be selected based on the position of the ion source electrodes 404 and/or 406 relative to the ionisation region 520. For example, where the beam-intersection ionisation region 520 is adjacent to the electron lens 404 (for example, the region 520 receives the electron beam 411 directly from the electron lens 404), the axis may be at an angle of 90 degrees or less relative to the first axis. In another example where the beam-intersection ionisation region 520 is adjacent to the extraction and reflection electrodes 406 (for example, the region 520 transmits the ion beam 407 directly to the extraction and reflection electrodes 406), the axis may be at an angle of between 90 and 180 degrees relative to the first axis. Both examples are illustrated in FIG. 5B, although only one beam-intersection region 520 may be present. The sample molecules 535 may be received along another axis at any suitable angle relative to the first axis. The calibrant and sample molecules may thus travel along a path that does not intersect the plurality of electrodes 404, 406.

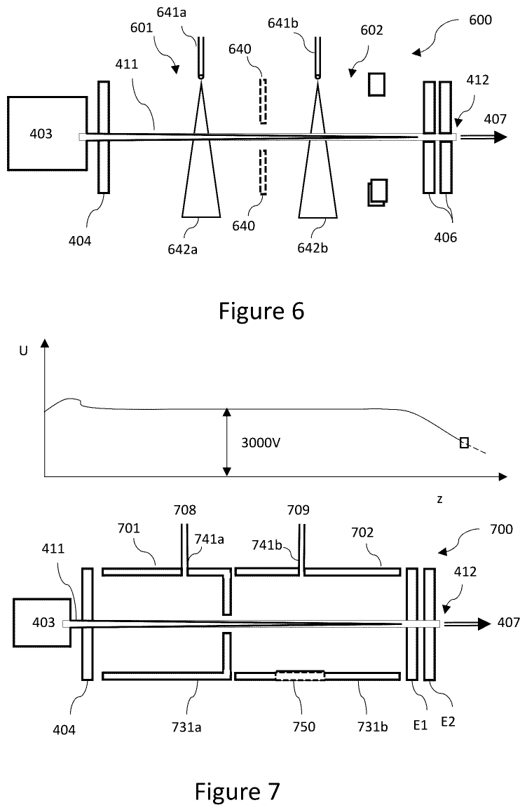

In another example, at least two beam-intersection ionisation regions 520 may be positioned sequentially. The ionisation region 530 may thus be arranged before or after the at least two beam-intersection ionisation regions 520. Alternatively, the ionisation region 530 may not be present. Such an exemplary embodiment will be discussed with reference to FIG. 6.

In cases where the ion source 500B comprises two or more calibrant ionisation regions (which need not each be beam-intersection ionisation regions), the calibrant molecules 525 may be different species of molecules. For example, one calibrant ionisation region may be used to ionise PFK molecules and another calibrant ionisation region may be used to ionise FC43 molecules. Thus, multiple calibrants can be introduced into the ion source in a straightforward manner, without increasing the amount of ion source electrode contamination and enabling sufficient ionisation of each species of calibrant molecules.

Referring still to FIG. 5B, the ionisation region 530 may be surrounded by an enclosing wall 531 to separate the ionisation region 530 and the beam-intersection ionisation region 520. The enclosing wall 531 may only partially enclose the ionisation region 530. Apertures in the enclosing wall may allow the electron beam 411 and ion beam 407 to be transmitted or guided through the ion source 500. Additional apertures may allow the sample molecules 535 to be introduced into the sample ionisation region 530.

The ion source may comprise two or more (for example, three) ionisation regions 530. The two or more ionisation regions 530 may be placed either side of one or more beam-intersection ionisation regions 520 and/or positioned sequentially. The sample molecules in some or all of the sample ionisation regions 530 may be different species of molecule. Some or all of the sample ionisation regions may be at least partially enclosed by a surrounding wall 531.

As discussed above in relation to FIGS. 4 and 5A, the beam-intersection ionisation region(s) 520 and ionisation region 530 may be of any appropriate dimensions, and may be different sizes or have different volumes. Similarly, some or all of the same type of ionisation region (beam-intersection, high vacuum or elevated pressure) may have differing dimensions or volumes. The calibrant molecules 525 and sample molecules 535 may be introduced along any suitable axis and need not be introduced on a common side of the ion source 500. Furthermore, the spatial spreads α and angular spreads θ shown in FIG. 5B are illustrative only.

Whilst the beam-intersection region 520 has been described above as a calibrant ionisation region and the ionisation region 530 as a sample ionisation region, it will be appreciated that calibrant molecules may be introduced into the ionisation region 530 (instead of sample molecules) and/or sample molecules may be introduced into one or both of the beam-intersection regions 520 (instead of the calibrant molecules).

FIG. 6 illustrates a specific exemplary embodiment of an axial ion source. In this example, the first and second ionisation regions 601, 602 of the ion source 600 are spatially separated with an optional dividing wall 640 (separation element) between the ionisation regions. A first molecular species beam 642a is introduced into the first ionisation region via a gas flow delivery element 641a. The gas flow delivery element may be a nozzle or tube (for example, a capillary tube) or another structure. A second molecular species beam 642b is received into the second ionisation region via gas flow delivery element 641b.

Both of the ionisation regions may preferably operate under high vacuum conditions, which may enable the beams 642a and 642b to be substantially directed (the molecules in the beam may travel in straight lines). The divergence of the beams 642a and 642b may thus be less than the length d of the first and second ionisation regions 601 and 602 and/or the angular spread θ of the beams 642a and 642b may not intersect a plane of the ion source electrodes 404 and 406.

The first molecular species beam 642a and the second molecular species beam 642b are illustrated as being centred along axes orthogonal to the axis of the electron beam 411, but one or both of the axes may be at another angle relative to the electron beam axis.

A waste receptacle (not shown) or dump may be placed opposite one or both of the inlets 641a, 641b. As molecules in the molecular beams 642a, 642b may travel along straight paths (for example, because the ionisation regions operate under high vacuum conditions), the molecules may be generally directed towards the waste receptacle. The molecules may thus be less likely to contaminate other components of the ion source 600. The waste receptacle(s) may be removable. This may mean that the waste receptacle can be cleaned by removing the waste receptacle from the ion source 600. Thus, the ion source 600 may be easier to clean and it may be possible to clean areas of small dimension that are not easily cleanable via known methods, such as in-situ cleaning, for example. The waste receptacle may be realised by a cylindrical element closed at one end. The waste receptacle may be present in any of the ion source implementations discussed herein.

FIG. 7 shows yet a further exemplary embodiment of an ion source, which may be surrounded by a vacuum, preferably a high vacuum. The electron beam 411 may be guided through a first ionisation volume 701, into which a first molecular species 708 may be introduced via an inlet 741a. The gas pressure within the first ionisation volume 701 may be elevated (for example, in a range between 1×10⁻⁴ and 1×10⁻² mbar), which may increase ionisation efficiency of the first molecular species 708. In other words, the first ionisation volume 701 may not be operated under high vacuum conditions. The first ionisation region 701 is preferably at least partially closed and is most preferably a conductance limited ionisation chamber. A conductance-limited ionisation chamber may be closed apart from the apertures from which particles (usually electrons), molecules (typically ions and neutral molecules) and/or atoms enter and exit the ionisation volume, for example.

The first ionisation volume 701 may be followed by a separate ionisation section 702, into which a second molecular species 709 is introduced via an inlet 741b. The separate ionisation section 702 may be operated at an elevated pressure (for example, in a range between 1×10⁻⁴ and 1×10⁻² mbar), which may increase ionisation efficiency of the second molecular species 709. In other words, the second ionisation volume may not be operated under high vacuum conditions. The second ionisation region 702 is preferably at least partially closed and is most preferably a conductance limited ionisation chamber.

There may be an optional gap 750 in the surrounding wall 731b opposite the inlet 741b. As the molecules 709 are uncharged (neutral) molecules, the molecules 709 that are not ionised by the electron beam 411 may typically reach the side of the second ionisation section 702 opposite the inlet 741b. When the gap 750 is present, the molecules 709 may thus be able to exit the second ionisation section 702 (for example, if the molecules 709 experience no or few collisions and thus may move along a straight path), which may improve contamination resistance of the ion source 700. This may be particularly useful when the molecules 709 are molecules having a high sticking probability, as the gap 750 may prevent the molecules 709 from contaminating the surface of the enclosing wall 731b opposite the inlet 741b. The illustrated gap 750 is exemplary only and may be larger or smaller than illustrated. Furthermore, although not shown, an optional gap may also or instead be present in surrounding wall 731a opposite the inlet 741a.

A waste receptacle (not shown) for the molecules 709 may additionally or alternatively be placed opposite the inlet 741b. Similarly, a waste receptacle for the molecules 708 may also or instead be placed opposite the inlet 741a. The waste receptacle(s) or dump(s) may be removable. This may mean that the waste receptacle can be cleaned by removing the waste receptacle from the ion source 700. Thus, the ion source 700 may be easier to clean and it may be possible to clean areas of small dimension that are not easily cleanable via known methods, such as in-situ cleaning, for example. The waste receptacle may be realised by a cylindrical element closed at one end. The waste receptacle may be present in any of the ion source implementations discussed herein.

Operating both ionisation regions 701, 702 at elevated pressures (for example, in a range between 1×10⁻⁴ and 1×10⁻² mbar) may enable the local pressures of each molecular species 708, 709 to be enhanced. For instance, efficient ionisation of different molecular species may require different local pressures. Providing two or more ionisation regions, the pressure inside of which can be separately controlled, may improve overall ionisation efficiency.

The ionisation regions 701, 702 may be configurable between high vacuum and elevated pressure operation modes. For example, the ion source 700 may be configured such that one or more of the ionisation volumes operate under high vacuum conditions. The first and/or second molecular species may thus emerge from the inlet 741a and/or 741b to form a beam along an axis that crosses or intersects the axis of the electron beam 411. Providing two or more ionisation regions, the pressure inside of which can be separately controlled, may allow improved control over ionisation efficiency and/or ion source electrode contamination.

Referring still to FIG. 7, in sector-field mass spectrometry, ions are typically accelerated before entering a magnetic and/or electrostatic sector and subsequently reaching one or more detectors. This may be achieved by applying an electric potential to the ion source and maintaining the one or more detectors at ground potential. Positive ions will be accelerated by the drop in potential between the ion source and the one or more detectors.

An exemplary potential is illustrated in FIG. 7 with respect to the ion source 700, in which the electric potential U is indicated along the ion source axis z. The electric potential may typically be 3000 V, but other electric potential values may be used. The electric potential within the ionisation regions 701, 702 may be constant, or substantially constant with a small potential difference (for example, 5V or less) to encourage ions into subsequent regions. The potential may begin to decrease in the region of the extraction electrodes E1 and E2. Positive ions may thus be accelerated out of the ion source by the decrease in potential, while negatively charged electrons experience the change in potential as an increase in potential and may be reflected back in the direction of the source cathode.

As discussed above with reference to FIG. 4, negative ions may be produced instead of positive ions. In this case, a voltage applied to the electrode E2 should be positive with respect to the voltage applied to the electrode E1 to extract negative ions from the ionisation volume 702. In other words, the potential may begin to increase in the region of the extraction electrodes E1 and E2 to accelerate negative ions out of the ion source. To prevent electrons from also being accelerated and drawn out of the ionisation volume 702 (as they have the same polarity as the negative ions), one or more magnets may be used to produce a magnetic field to deflect electrons away from the first axis (which may correspond to the ion source axis). In one example, the magnetic field may deflect electrons away from the first axis before reaching the region between the electrodes E1 and E2. For instance, the magnetic field may deflect the electrons away from the first axis in the ionisation volume 702 in a region near the extraction and/or reflection electrodes E1 and E2).

Since an axial magnetic field may be applied to the ion source to guide the electrons and ions along a common axis of the ion source (as discussed in respect of FIG. 4), the deflecting magnetic field may comprise a modification to the axial magnetic field. In another example, the deflecting magnetic field may be a separate magnetic field (for example, produced by a different magnet).

In this implementation, electrons may not be turned back towards the cathode but may instead make only a single pass through the ionisation volume. It should be noted that, since the electron beam axis is still parallel to the ion beam axis (even though the electrons may be deflected away from the first axis before reaching the extraction and/or reflection electrodes E1 and E2), this implementation still corresponds to an axial ion source.

The ions can thus be extracted from the ion source 700 whilst deflecting electrons away from the ion source exit 412. This is because, although the magnetic field may deflect electrons away from the first axis, the (negative) ions may not be deflected (or may not be significantly deflected) from the first axis due to their larger mass.

Different implementations of dedicated ionisation regions may be combined. The various combinations may enable specific benefits, such as reduced or limited ion source electrode contamination and high ionisation efficiency.

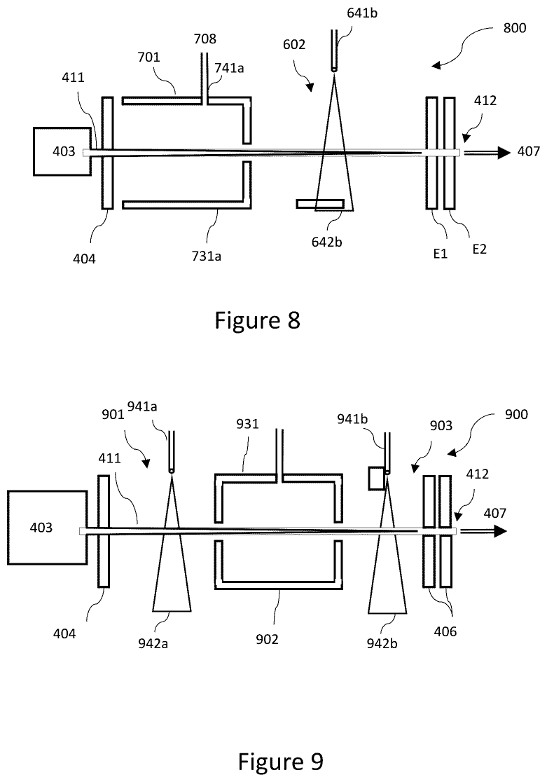

For example, FIG. 8 illustrates an exemplary ion source in which an ionisation volume and a directed molecule beam are implemented. The ion source 800 may have a surrounding vacuum, which may be high vacuum. In the ion source 800, a first molecular species 708 may be received into the ionisation volume 701 via the inlet 741a. The at least partially closed ionisation volume 701 may enable high ionisation efficiency to be achieved for the first molecular species 708.

The second molecular species may be received as a directed molecular beam 642b into the second ionisation region 602, which may be achieved by providing the second ionisation region 602 as a high vacuum region. Although the second ionisation region 602 is illustrated as being an open (non-closed) region, it will be understood that a separation or surrounding element (for example, a wall) may be present. Furthermore, although not shown, a waste receptacle as discussed with respect to FIGS. 6 and 7 may be placed opposite inlet 641b.

The second molecular species, which preferably comprises neutral calibrant gas molecules, may emerge from the inlet 641b to form a beam 642b along an axis that crosses or intersects the axis of the electron beam 411. While the ionisation efficiency of the second molecular species may be lower than that of the first molecular species that is accumulated within the first ionisation volume 701 (as the pressure in the second ionisation volume 602 may be lower), a sufficient number of calibrant ions may still be supplied to the mass analyser or another downstream element.

The directed beam 642b may allow contact of the second molecular species with the extraction electrodes E1, E2 to be minimised. This may be particularly useful when the second molecular species are calibrant molecules with high sticking probability, such as PFK or PFTBA, for example. The reflection of electrons and extraction of ions between electrodes E1 and E2 may preferably also take place in (high) vacuum. The mechanical dimensions of electrodes E1 and E2 may be determined by electron and/or ion optical considerations.

Additionally, providing the second ionisation region 602 as a high vacuum region may enable a more monoenergetic distribution of ion kinetic energies. Due to the change in potential in the region of the extraction electrodes E1 and E2 (as illustrated in FIG. 7), ions generated in this region may not receive the full acceleration voltage (for example, 3000 V) that ions generated in other regions (for example, the first ionisation region 701 or towards a portion of the second ionisation region 702 from which the electron beam 411 is received) may receive. The ions generated in the extraction electrodes region may therefore not pass through or be focussed into a downstream element of an analytical instrument. For example, the ions may not be able to pass through one or more sector field instruments and/or may not reach one or more detectors. However, by providing the second ionisation region 602 as a high vacuum region, the generation of ions in the extraction electrode region can be suppressed. Thus, the proportion of ions generated in the second ionisation region 602 receiving the full acceleration voltage may be greater. This may result in a less broad distribution of ion kinetic energies, which may in turn improve focussing of ions into a downstream element of the analytical instrument.

In another example, the first and second ionisation regions 701, 602 may be reversed, such that the ionisation region closer to or adjacent to the electron lens 404 may receive a directed molecular beam and the second ionisation is an ionisation volume. In this case, the directed beam may allow contact of the first molecular species with the electron lens electrode 404 to be minimised and ionisation efficiency of the second molecular species to be increased.

As discussed above with reference to FIG. 4, more than two separate ionisation regions may be realised. One exemplary embodiment including three ionisation regions is illustrated in FIG. 9, which shares similarities with the embodiments discussed in relation to FIGS. 5B, 6 and 8. In this exemplary embodiment, the ion source 900 comprises two beam-intersection ionisation regions 901, 903, in which molecules are directed along an axis that intersects the electron beam axis. At least some of the molecules received from the respective inlets 941a, 941b may thus be ionised by the intersection of the molecular beams 942a, 942b and the electron beam 411.

In FIG. 9, a further ionisation region 902 is included between the two ionisation regions 901, 903. However, it will be appreciated that the further ionisation region 902 could be included elsewhere in the ion source 900. The further ionisation region 902 is an ionisation volume at least partially enclosed by a surrounding wall 931, and may be an ionisation chamber. The surrounding wall 931 may mean that molecules may be received into the further ionisation region 902 along any axis and still be ionised by the electron beam 411 without risk of contaminating the ion source electrodes 404 and/or 406. Furthermore, the surrounding wall 931 may allow for an increased or elevated gas pressure within the ionisation region 902, which may increase the ionisation efficiency within the further ionisation region 902. The ionisation efficiency may be further improved when the further ionisation region 902 comprises a conductance-limited ionisation chamber. A conductance-limited ionisation chamber may be closed apart from the apertures from which particles (usually electrons) and molecules (typically ions and neutral molecules, but may include atoms) enter and exit the ionisation volume, for example.

The arrangement of ionisation regions 901, 902, 903 in FIG. 9 may be particularly beneficial for achieving high ionisation efficiency whilst avoiding or reducing electrode contamination. The arrangement may also be particularly useful for experiments requiring a lock mass during measurements.

In one example, the molecules introduced into each region 901, 902, 903 may be of the same species. The molecules can thus be efficiently ionised in the further ionisation region 902, as well as being ionised in the two ionisation regions 901, 903 with limited or reduced contamination of the electrodes 404, 406. It may therefore be possible to ionise a greater number of molecules without an accordingly increased electrode contamination.

In another example, some of the received molecules may be of different species. The molecules received into one or both of the two ionisation regions 901, 903 may be calibrant molecules, for instance. The calibrant molecules may also be of different species. Providing the calibrant molecules along an axis that interests the electron beam axis may reduce or prevent contamination of the electrodes 404, 406. This arrangement may also result in a need to clean other parts of the ion source 900 less frequently (for example, if a waste receptacle is provided along the axis, opposite one or both of the inlets 941a and/or 941b).

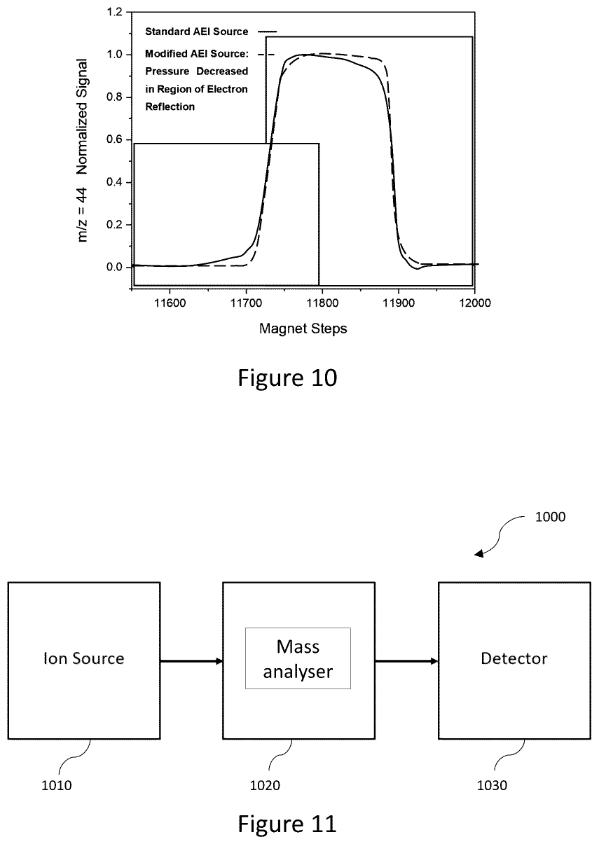

With reference to FIG. 10, there is shown a graph illustrating a difference in peak shape obtained using a sector-field mass analyser for a conventional axial ion source compared to an axial ion source with extraction electrodes E1 and E2 placed in high vacuum to minimize ionisation in that region. One issue that may occur with axial ion sources is that a distribution of ion kinetic energies may be typically much broader than that of ions generated in a Nier-type ion source. For example, ions generated in the region adjacent the extraction electrodes E1 and E2 may have a lower kinetic energy than the majority of ions generated within an ionisation region. An ion beam having a broad distribution of ion kinetic energies may be only partially focussed into the detector of the mass analyser. Thus, a percentage of ions from the ion beam is omitted from measurements, which may affect the accuracy of the measurements. For example, a measurement of isotope ratios may be inaccurate. The broad distribution of ion kinetic energies may be a particular issue with single-focussing sector-field mass analysers, where only a single magnetic sector may be used to separate ions according to their mass-to-charge ratio.

Incomplete focussing of the ion beam into the detector may result in an inaccurate peak shape—for example, a peak without a flat peak plateau. Such a peak is illustrated in FIG. 10 by the solid line. However, by providing a high vacuum region near the extraction electrodes E1 and E2, generation of ions can be suppressed in the region around the extraction electrodes E1 and E2. The distribution of ion kinetic energies may thus be more monoenergetic. The dashed line in FIG. 10 illustrates the peak shape after decreasing the pressure in the region near the extraction electrodes E1 and E2 (in other words, providing a higher vacuum region). As can be seen from FIG. 10, the peak shape in the case where the region near the extraction electrodes E1 and E2 is a high vacuum region is improved compared to the elevated pressure ionisation region. Thus, using an ion source geometry such as, for example, shown in FIG. 8, that may prevent a majority of molecules from being ionized near electrodes E1 and E2 may enable a more monoenergetic ion source in addition to, or instead of, enabling neutral molecules to be kept distal from the ion source electrodes 404 and/or 406. The distribution of ion kinetic energies being less broad (more monoenergetic) may result in improved focussing of the ion beam into a detector of a mass analyser or another downstream element.

A mass spectrometer in which an ion source of the disclosure may be utilized is schematically shown in FIG. 11. The mass spectrometer 1000 may comprise an ion source 1010, at least one mass analyser 1020 and a detector or a plurality of detectors 1030. The at least one mass analyser 1020 may comprise a multipole mass analyser (such as a quadrupole mass analyser, for example), a magnetic sector mass analyser and/or another type of mass analyser. The at least one detector 1030 may comprise Faraday cups, at least one secondary electron multiplier (SEM) detector, and/or other detectors. The ion source 1010 may comprise an ion source 400, 500A, 500B, 600, 700, 800 or 900 as described above. Although not shown, interface components for interfacing between the ion source 1010, the at least one mass analyser 1020 and the detector 1030 may be present. For example, components for transmitting, guiding and/or storing ions and/or other components may be present.

The disclosure may further provide use of an electron impact ion source. The use may comprise any one or more of the features discussed herein. For example, the first and/or second molecules may comprise calibrant molecules and, optionally, the calibrant molecules may comprise perfluorokerosene (PFK) or perfluorotributylamine (PFTBA).

It will be understood that, although examples of the ion source are described above primarily in the context of electron ionisation, the ion source disclosed herein may additionally or alternatively be configured for another form of ionisation. For example, chemical ionisation is a technique that also employs the use of an electron beam. Similarly, it will be appreciated that, although examples of the ion source have been described above generally with reference to an electron beam generating positive ions, it will be appreciated that the polarity of the ions and/or the beam could be reversed. For example, negative chemical ionisation could be used to generate negative ions or the electron beam may be used to generate negative ions. As discussed above with reference to FIG. 7, an increasing potential may thus be used to extract the negative ions from the ion source. In the case where an electron beam is used (or other negative charged particles are used, such as in a negative ion beam), a (modified) magnetic field may be employed to prevent electrons from being extracted.

The methods described herein may be implemented with computer system configurations including hand-held devices, microprocessor systems, microprocessor-based or programmable consumer electronics, minicomputers, mainframe computers and the like. The embodiments can also be practiced in distributed computing environments, where tasks are performed by remote processing devices that are linked through a network.

The computer system may include a processor, such as a central processing unit (CPU). The processor may execute logic in the form of a software program. The computer system may include a memory including volatile and non-volatile storage medium. The different parts of the system may be connected using a network (e.g. wireless networks and wired networks). The computer system may include one or more interfaces. The computer system may contain a suitable operating system such as UNIX (including Linux) or Windows®, for example.

Certain embodiments can also be embodied as computer-readable code on a non-transitory computer-readable medium. The computer readable medium is any data storage device than can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion. Although embodiments according to the disclosure have been described with reference to particular types of devices and applications (particularly mass analysers and spectrometers) and the embodiments have particular advantages in such case, as discussed herein, approaches according to the disclosure may be applied to other types of device and/or application. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

The methods and apparatus of the present disclosure can be utilised with a variety of electrode structures. Individual electrodes can be planar, hemispherical, rectangular or of other shapes. The electrodes may be PCB printed electrodes.

It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (e.g., 10%, 20% or 50%) or less than 5% (for example, 2% or 1%).

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an electrode) means “one or more” (for instance, one or more electrodes).

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B” is true, or both “A” and “B” are true. Furthermore, the use of bracketed terms is inclusive, such that the phrase “(C) D” is true when “D” is true”, or both “C” and “D” are true. For example, the term “(high) vacuum” may mean “high vacuum” or “vacuum”.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed, or referred to with a different numerical indicator, without changing the scope of the invention. That is, an element termed a “first” element (for example, a first ionisation region 401) may instead be termed a “second” element (a second ionisation region 401, for instance) and an element termed a “second” element (for example, a second ionisation region 401) may instead be considered a “first” element (a first ionisation region 401, for instance).

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

All literature and similar materials cited in this application, including but not limited to patents, patent applications, articles, books, treaties and internet web pages are expressly incorporated by reference in their entirety for any purpose. Unless otherwise described, all technical and scientific terms used herein have a meaning as is commonly understood by one of ordinary skill in the art to which the various embodiments described herein belongs.

1. An electron impact ion source comprising:
a first electron impact ionisation region comprising an aperture configured to receive first molecules into the first ionisation region, the first ionisation region being configured to receive an electron beam along a first axis to generate a first ion beam along the first axis from the first molecules; and
a second, separate electron impact ionisation region comprising an inlet configured to receive second molecules into the second ionisation region, the second ionisation region configured to receive the electron beam along the first axis to generate a second ion beam along the first axis from the second molecules.

2. The electron impact ion source according to claim 1, wherein the inlet is configured to receive the second molecules along a second axis that intersects the first axis to ionise the second molecules and/or the aperture is configured to receive the first molecules along a receiving axis that intersects the first axis to ionise the first molecules.

3. The electron impact ion source according to claim 1, wherein the second ionisation region is spatially separated from the first ionisation region such that the first molecules are predominantly ionised in the first ionisation region and the second molecules are predominantly ionised in the second ionisation region.

4. The electron impact ion source according to claim 1, wherein the ion source further comprises a separation element between the first ionisation region and the second ionisation region, wherein the separation element preferably at least partially surrounds one or both of the first and second ionisation regions.

5. The electron impact ion source according to claim 1, wherein at least one of the first and second ionisation regions is an ionisation chamber and/or at least one of the first and second ionisation regions is configured to operate at a vacuum.

6. The electron impact ion source according to claim 5, wherein the vacuum is a high or ultra-high vacuum.

7. The electron impact ion source according to claim 6, wherein the electron impact ion source is configured such that a mean free path of the first and/or second molecules is more than half a length of the respective first and/or second ionisation region along a dimension parallel to the first axis.

8. The electron impact ion source according to claim 7, wherein the mean free path is greater than the length or at least ten times greater than the length.

9. The electron impact ion source according to claim 1, wherein
the first and/or second ionisation region is configured such that:
a spread of the respective first molecules and/or second molecules along a dimension parallel to the first axis is less than the length; and/or
a spread of the respective first molecules and/or second molecules does not intersect a plane of one or more ion source electrodes.

10. The electron impact ion source according to claim 2, wherein:
the second ionisation region is configured such that the second axis does not intersect the plane of the one or more ion source electrodes; and/or
the first ionisation region is configured such that the receiving axis does not intersect the plane of one or more ion source electrodes.

11. The electron impact ion source according to claim 2, wherein the second axis is perpendicular to the first axis.

12. The electron impact ion source according to claim 1, wherein the first and/or second molecules comprise calibrant molecules, wherein the calibrant molecules preferably comprise perfluorokerosene (PFK) or perfluorotributylamine (PFTBA).

13. The electron impact ion source according to claim 2, further comprising a waste receptacle positioned along the second axis to receive un-ionised molecules and/or further comprising a waste receptacle positioned along the receiving axis to receive un-ionised molecules.

14. The electron impact ion source according to claim 13, wherein at least one of the waste receptacles positioned along the second axis and the receiving axis is removable.

15. The electron impact ion source according to claim 1, further comprising one or more magnets configured to generate an axial magnetic field to guide electrons and ions along a common axis.

16. A method of electron ionisation comprising:
receiving an electron beam into a first ionisation region along a first axis and generating, by the electron beam, a first ion beam along the first axis from first molecules in the first ionisation region; and
receiving the electron beam into a second, separate ionisation region along the first axis and generating, by the electron beam, a second ion beam along the first axis from second molecules in the second ionisation region.

17. The method according to claim 16, further comprising receiving second molecules into the second ionisation region along a second axis that intersects the first axis to generate the second ion beam and/or receiving first molecules into the first ionisation region along a receiving axis that intersects the first axis to generate the first ion beam.

18. The method according to claim 16, wherein:
the second ionisation region is spatially separated from the first ionisation region such that the first molecules are predominantly ionised in the first ionisation region and the second molecules are predominantly ionised in the second ionisation region; and/or
a separation element is arranged between the first ionisation region and the second ionisation region; and/or
wherein at least one of the first and second ionisation regions is an ionisation chamber.

19. The method according to claim 16, further comprising operating the first and/or second ionisation region at a vacuum.

20. The method according to claim 19, wherein the vacuum is a high or ultra-high vacuum.

21. The method according to claim 20, wherein a mean free path of the first and/or second molecules is more than half a length of the first and/or second ionisation region along a dimension parallel to the first axis, greater than the length or at least ten times greater than the length.

22. The method according to claim 17, wherein:
a spread of the first molecules and/or second molecules along the dimension is less than the length; and/or
a spread of the first molecules and/or second molecules does not intersect a plane of one or more ion source electrodes; and/or
the second axis does not intersect the plane of the one or more ion source electrodes; and/or
a receiving axis along which the first molecules are received into the first ionisation region does not intersect the plane of the one or more ion source electrodes.

23. The method according to claim 16, wherein the first and/or second molecules comprise calibrant molecules.

24. A computer-readable storage medium storing computer-executable instructions which, when executed by a computer, cause the computer to control an analytical instrument comprising an electron impact ion source to carry out the method of claim 16.

25. A controller configured to operate an analytical instrument comprising an electron impact ion source in accordance with the method of claim 16.

26. An analytical instrument comprising an electron impact ion source according to claim 1.

27. The analytical instrument according to claim 26, wherein the analytical instrument comprises a mass spectrometer.
